(19) United States
(12) Patent Application Publication
(10) Pub. No.: US 2003/0198936 A1
(43) Pub. Date: Oct. 23, 2003

(54) Real-time learning assessment method for interactive teaching conducted by means of portable electronic devices

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/127,716

(22) Filed: Apr. 23, 2002

(51) Int. Cl. G09B 3/00

(52) U.S. Cl. 434/351

(57) ABSTRACT

A real-time learning assessment method for interactive teaching conducted by means of portable electronic devices. The invention involves using an assessment system to carry out real-time assessment of the result of learning conducted by means of portable electronic devices. The assessment system compiles the statistics for the number of times students raise questions with portable electronic devices during a semester and their scores on tests taken with portable electronic devices, for creating records of routine assessment conducted by means of portable electronic devices, with a view to improving the existing teaching methods and the routine academic performance assessment methods.

### FIELD OF THE INVENTION

The invention relates to an academic performance assessment method for interactive teaching, and more particularly, a real-time learning assessment method for interactive teaching conducted by means of portable electronic devices.

### BACKGROUND OF THE INVENTION

The existing methods for assessing the result of students' learning involve routine tests taken during a semester, nonscheduled quizzes given by individual teachers, and questions asked by teachers during a lesson, etc.—all are aimed at assessing individual students' degree of participation in their learning process. As for these types of scoring methods, teachers or students are appointed to record the students' scores after a quiz. In the event that quizzes are given frequently, not only will recording students' scores be time-consuming, but statistical analysis of the scores will also be rather complicated and inconvenient. Unlike a semester test, a quiz can seldom be scored with a computer, causing teachers great inconvenience.

As regards the assessment of students' academic performance in class, it is necessary for teachers to record students' questioning behavior. The teachers have to take down any questions raised by the students so that the record will become the basis for future assessment of the students' academic performance in class. However, the problem is that the teachers have to bring a record sheet to a classroom for each lesson. If the record sheet is lost, statistical analysis will be unfair. In addition, a score derived from a student's participation in interactive teaching and learning in a classroom has to be weighted before being added to the student's total score. These complicated calculations increase the teachers' workload when the teachers have to mark examination papers at the end of a semester.

With distance learning, network teaching and other teaching methods that have recently been developed, a simple and easy method is indispensable to the effective replacement of traditional teaching and learning methods by means of digital equipment as well as the development of corresponding learning and assessment mechanisms.

### OBJECT AND SUMMARY OF THE INVENTION

In view of this, the invention discloses a real-time learning assessment method for interactive teaching conducted by means of portable electronic devices, for coping with the aforesaid problems. This invention is particularly aimed at portable electronic devices, such as Personal Digital Assistants (PDAs) or portable computers. It involves using the portable electronic devices to conduct interactive learning and simple academic performance assessment. With the method put forth by the invention, the scores on tests taken by students and the accumulated numbers of times individual students have raised questions in class are worked out automatically and analyzed in a statistical way, so as to facilitate teachers' assessment of individual students' overall academic performance in a semester.

The real-time learning assessment method put forth by the invention for interactive teaching conducted by means of portable electronic devices includes the following steps:

Link a teaching PDA with learning PDAs. Input a test command into the teaching PDA for setting a test mode for the teaching PDA and the learning PDAs. The teaching PDA sends a test to the learning PDAs. The teaching PDA starts a time count and gives a stop answering command when the time is up. The teaching PDA receives the answers given by the learning PDAs to the test. The teaching PDA sends the learning PDAs the scores on the test.

Link a teaching PDA with learning PDAs. If a student raises a question with a PDA, the teaching PDA receives the question raised through the learning PDA in class. The teaching PDA then conducts statistical analysis on the number of times the student has raised questions in class.

As regards the details contents and concepts of the invention, explanations and drawings are as follows.

### DETAILED DESCRIPTION OF THE PREFERRED EMBODIMENT

The real-time learning assessment method put forth by the invention for interactive teaching conducted by means of portable electronic devices is particularly aimed at portable electronic devices, such as PDAs. The method involves using a wireless Local Area Network (LAN) formed by several PDAs to achieve the purpose of interactive learning. The LAN comprises several auxiliary learning PDAs and a teaching PDA that plays a pivotal role. The LAN thus functions like a digital classroom. The method changes the ways teaching and routine academic performance assessments are presently conducted.

A preferred embodiment is depicted below to give a concrete explanation as to why the method put forth by the invention is feasible. FIG. 1 shows the structure of interactive teaching conducted through PDAs and its explanation is as follows:

A teaching PDA 100 can be regarded as a server, as it receives data sent by individual learning PDAs 200. Both types of PDAs are linked up by a wireless network, avoiding the hassle of connecting computers by a physical line and problems like an insufficient number of sockets. Since the calculation of scores in routine academic performance assessment requires a statistical assessment system, the invention is configured in such a way that the statistical assessment system is constructed on the teaching PDA 100, so as to conduct real-time statistical analysis on the scores in routine academic performance assessment and retrieve students' feedback anytime.

FIG. 2 shows a flowchart for a test taken through a teaching PDA for the PDA-based interactive teaching put forth by the invention. It illustrates the process of a test taken through a teaching PDA. Its explanation is as follows:

Firstly, Link a teaching PDA 100 with learning PDAs 200 (step 300). Once a teacher inputs a test command into the teaching PDA 100 for setting a test mode for the teaching PDA 100 and the learning PDAs 200 (step 310), the teaching PDA 100 sends a test to the learning PDAs 200 (step 320). The teaching PDA 100 starts a time count and gives a stop answering command to the students when the time is up (step 330), and the students have to stop working on the test immediately. The teaching PDA 100 receives the answers given by the learning PDAs 200 to the test (step 340). After figuring out the scores on the test with a PDA, the teacher sends the scores on the test to the learning PDAs 200 through the teaching PDA 100 (step 350).

FIG. 3 shows a flowchart for a test taken through learning PDA for the PDA-based interactive teaching put forth by the invention. It illustrates the process of a test taken through learning PDA. Its explanation is as follows:

Firstly, Link a teaching PDA 100 with learning PDAs 200. If a teacher decides to hold an examination, the learning PDAs 200 receive a test from the teaching PDA 100 (step 400). The learning PDAs 200 record the answers given by the students to the test (step 410). Once the learning PDAs 200 receive a stop answering command from the teaching PDA 100 (step 420), the learning PDAs 200 send the teaching PDA 100 the answers to the test (step 430). The teaching PDA 100 works out the scores immediately and sends the data to the learning PDAs 200. The learning PDAs 200 receive the scores on the test from the teaching PDA 100 (step 440).

FIG. 4 shows a flowchart for raising a question in class through a teaching PDA for the PDA-based interactive teaching put forth by the invention. It illustrates the process of raising a question in class through a teaching PDA. Its explanation is as follows:

Firstly, Link a teaching PDA 100 with learning PDAs 200 (step 300). If a student raises a question with a PDA, the teaching PDA 100 receives the question from the learning PDA 200 (step 500). The teaching PDA 100 conducts statistical analysis on the number of times the student has raised questions in class (step 510).

FIG. 5 shows a flowchart for raising a question in class through learning PDA for the PDA-based interactive teaching put forth by the invention. It illustrates the process of raising a question in class through learning PDA. Its explanation is as follows:

A student inputs a question, which s/he is going to raise in class, into learning PDA 200 (step 600). The learning PDA 200 then sends the question to the teaching PDA 100 (step 610).

### EFFECT OF THE INVENTION

According to the aforesaid analysis of the technical plan put forth by the invention, numerous advantages are found in the actual application of the method of the invention. The advantages are as follows:

1. Creation of records for routine assessment conducted by means of portable electronic devices, saving teachers a lot of time.

2. Accurate and efficient automatic statistical analysis of individual students' scores on tests and class participation.

3. Improvement in the ways teaching and routine academic performance assessments are presently conducted.

While the invention has been described by way of example and in terms of a preferred embodiment, it is to be understood that the invention is not limited thereto. It should be understood that the detailed description and specific examples, while indicating preferred embodiments of the invention, are given by way of illustration only, since various changes and modifications within the spirit and scope of the invention will become apparent to those skilled in the art from this detailed description. Therefore the scope of protection for the invention should conform to the claims attached below.

### BRIEF DESCRIPTION OF THE DRAWINGS

FIG. 1 shows the structure of the PDA-based interactive teaching put forth by the invention.

FIG. 2 shows a flowchart for a test taken through a teaching PDA for the PDA-based interactive teaching put forth by the invention.

FIG. 3 shows a flowchart for a test taken through learning PDA for the PDA-based interactive teaching put forth by the invention.

FIG. 4 shows a flowchart for raising a question in class through a teaching PDA for the PDA-based interactive teaching put forth by the invention.

FIG. 5 shows a flowchart for raising a question in class through learning PDA for the PDA-based interactive teaching put forth by the invention.

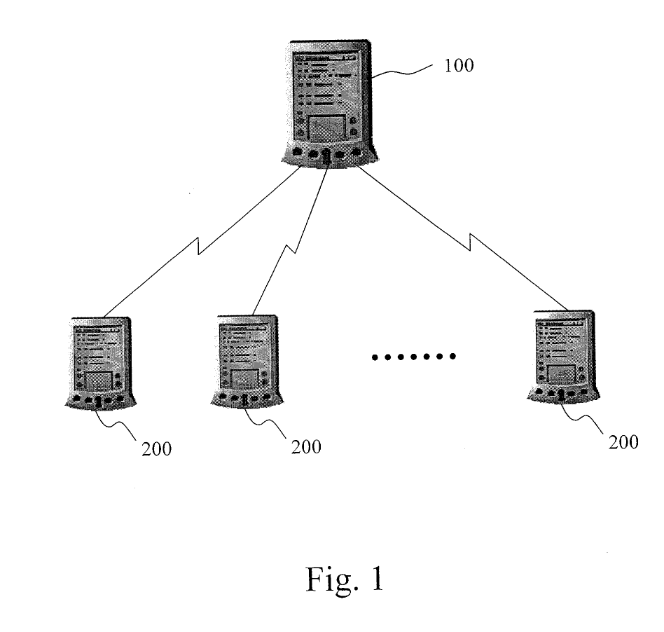

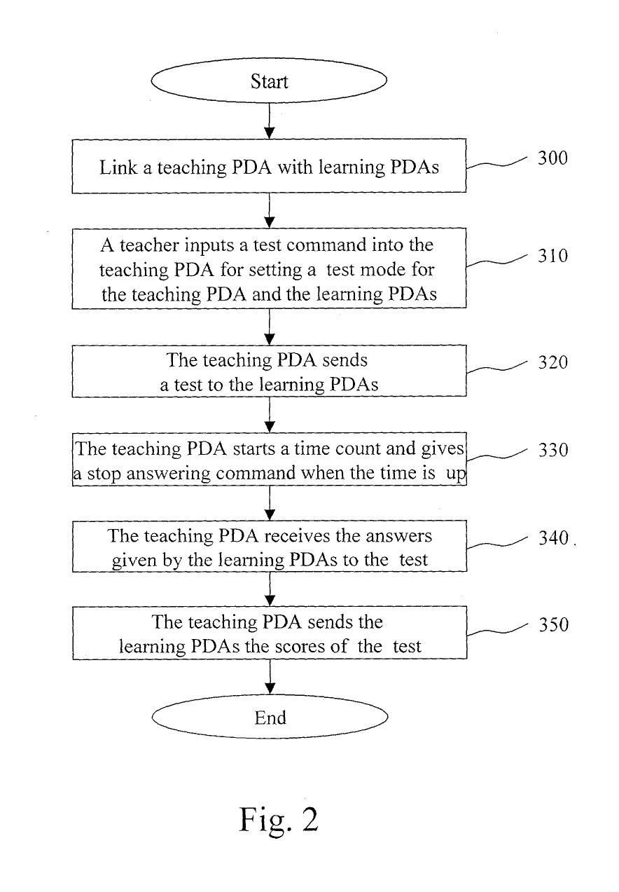

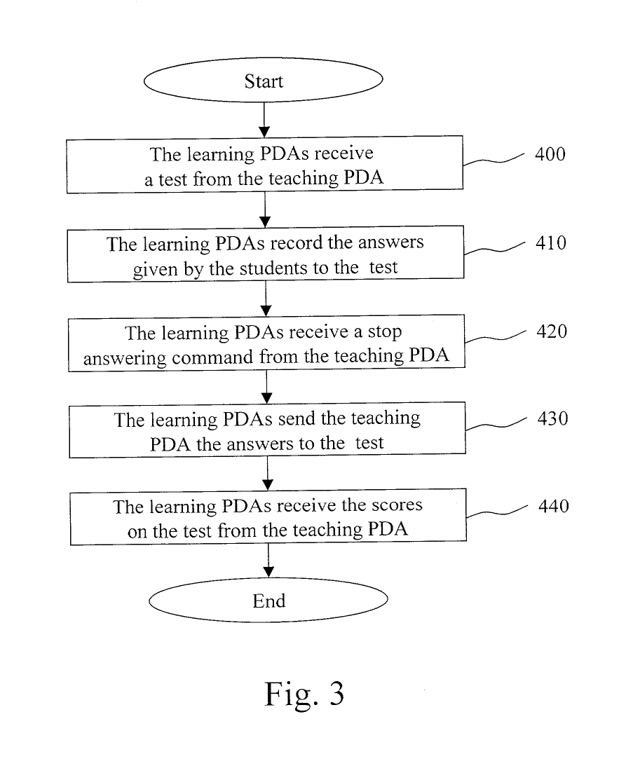

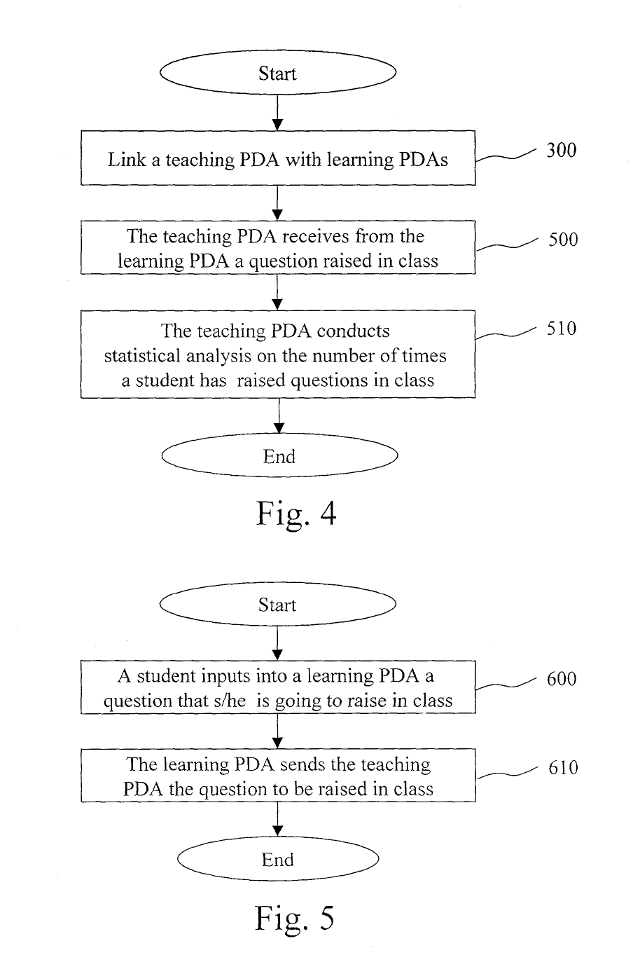

What is claimed is:

1. A real-time learning assessment method for interactive teaching conducted by means of portable electronic devices; it enables interactive teaching to be conducted by means of a teaching-oriented portable electronic device with wireless communication function and plurality of learning-oriented portable electronic devices; real-time statistical analysis is conducted on plurality of scores in routine academic performance assessment with the teaching-oriented portable electronic device; it comprises the steps of:
link the teaching-oriented portable electronic device with the plurality of learning-oriented portable electronic devices;
inputs a test command into the teaching-oriented portable electronic device for setting a routine test mode for the teaching-oriented portable electronic device and the plurality of learning-oriented portable electronic devices;
the teaching-oriented portable electronic device sends the plurality of learning-oriented portable electronic devices a routine test;
the teaching-oriented portable electronic device starts a time count and gives a stop answering command when time's up;
the teaching-oriented portable electronic device receives plurality of answers given by the plurality of learning-oriented portable electronic devices to the routine test; and
the teaching-oriented portable electronic device sends the plurality of scores on the routine test to the plurality of learning-oriented portable electronic devices.

2. The real-time learning assessment method for interactive teaching conducted by means of portable electronic devices of claim 1, wherein the teaching-oriented portable electronic device also comprises a real-time learning assessment module for figuring out the plurality of scores on the routine test.

3. The real-time learning assessment method for interactive teaching conducted by means of portable electronic devices of claim 1, wherein the teaching-oriented portable electronic device also comprises a routine test module for conducting a routine test.

4. The real-time learning assessment method for interactive teaching conducted by means of portable electronic devices of claim 1, wherein the teaching-oriented portable electronic device can select from a group of personal digital assistant (PDA), portable computer, mobile communication device, e-schoolbag, and WebPad.

5. The real-time learning assessment method for interactive teaching conducted by means of portable electronic devices of claim 1, wherein the plurality of learning-oriented portable electronic devices can select from a group of personal digital assistant (PDA), portable computer, mobile communication device, e-schoolbag, and WebPad.

6. A real-time learning assessment method for interactive teaching conducted by means of portable electronic devices; it enables interactive teaching to be conducted by means of a teaching-oriented portable electronic device with wireless communication function and a plurality of learning-oriented portable electronic devices; real-time statistical analysis is conducted on a plurality of scores in routine academic performance assessment with the teaching-oriented portable electronic device; it comprises the steps of:
the plurality of learning-oriented portable electronic devices receive a routine test from the teaching-oriented portable electronic device:
the plurality of learning-oriented portable electronic devices record an answer given by students to a routine test;
the plurality of learning-oriented portable electronic devices receive a stop answering command from the teaching-oriented portable electronic device;
the plurality of learning-oriented portable electronic devices send the teaching-oriented portable electronic device an answer to the routine test; and
the plurality of learning-oriented portable electronic devices receive a score on the routine test from the teaching-oriented portable electronic device.

7. The real-time learning assessment method for interactive teaching conducted by means of portable electronic devices of claim 6, wherein the teaching-oriented portable electronic device also comprises a real-time learning assessment module for figuring out the plurality of scores on the routine test.

8. The real-time learning assessment method for interactive teaching conducted by means of portable electronic devices of claim 6, wherein the teaching-oriented portable electronic device also comprises a routine test module for conducting a routine test.

9. The real-time learning assessment method for interactive teaching conducted by means of portable electronic devices of claim 6, wherein the teaching-oriented portable electronic device can select from a group of personal digital assistant (PDA), portable computer, a mobile communication device, e-schoolbag, and WebPad.

10. The real-time learning assessment method for interactive teaching conducted by means of portable electronic devices of claim 6, wherein the plurality of learning-oriented portable electronic devices can select from a group of personal digital assistant (PDA), portable computer, mobile communication device, e-schoolbag, and WebPad.

11. A real-time learning assessment method for interactive teaching conducted by means of portable electronic devices; it enables interactive teaching to be conducted by means of a teaching-oriented portable electronic device with wireless communication function and plurality of learning-oriented portable electronic devices; real-time statistical analysis is conducted with the teaching-oriented portable electronic device on plurality of numbers of times questions are raised in class; it comprises the steps of:
link the teaching-oriented portable electronic device with the plurality of learning-oriented portable electronic devices;
input into a learning-oriented portable electronic device a question to be raised in class;
the learning-oriented portable electronic device sends the teaching-oriented portable electronic device the question to be raised in class;
the teaching-oriented portable electronic device receives from the plurality of learning-oriented portable electronic devices a question to be raised in class; and
the teaching-oriented portable electronic device conducts statistical analysis on the plurality of numbers of times questions are raised in class.

12. The real-time learning assessment method for interactive teaching conducted by means of portable electronic devices of claim 11, wherein the teaching-oriented portable electronic device also comprises a real-time learning assessment module for carrying out statistical analysis on the plurality of numbers of times questions are raised in class.

13. The real-time learning assessment method for interactive teaching conducted by means of portable electronic devices of claim 11, wherein the teaching-oriented portable electronic device also comprises a routine test module for conducting a routine test.

14. The real-time learning assessment method for interactive teaching conducted by means of portable electronic devices of claim 11, wherein the teaching-oriented portable electronic device can select from a group of personal digital assistant (PDA), portable computer, mobile communication device, e-schoolbag, and WebPad.

15. The real-time learning assessment method for interactive teaching conducted by means of portable electronic devices of claim 11, wherein the plurality of learning-oriented portable electronic devices can select from a group of personal digital assistant (PDA), portable computer, mobile communication device, e-schoolbag, and WebPad.
